(19) United States
(12) Patent Application Publication
(10) Pub. No.: US 2005/0192960 A1
(43) Pub. Date: Sep. 1, 2005

(54) Feature-pattern output apparatus, feature-pattern output method, and computer product

(75) Inventors: Hiroya Inakoshi, Kawasaki (JP); Seishi Okamoto, Kawasaki (JP); Akira Sato, Kawasaki (JP); Takahisa Ando, Kawasaki (JP); Toru Ozaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/118,486

(22) Filed: May 2, 2005

Related U.S. Application Data
(63) Continuation of application No. PCT/JP02/11451, filed on Nov. 1, 2002.

(51) Int. Cl. G06F 7/00

(52) U.S. Cl. 707/6

(57) ABSTRACT

A feature-pattern output apparatus, which has a database in which data formed of a plurality of items is classified as a plurality of classes, and outputs a combination of items forming a feature of each of the classes as a feature pattern of the class, includes a similar-data extracting unit that extracts, when input data is received, similar data that is similar to the input data for each of the classes from the database; a similar-pattern-set calculating unit that calculates a similar pattern set for each of the classes from the similar data extracted; and a feature-pattern calculating unit that calculates a feature pattern for each of the classes from the similar pattern set calculated.

### BACKGROUND OF THE INVENTION

1) Field of the Invention

The present invention relates to a feature-pattern output apparatus, a feature-pattern output method, and a feature-pattern output program in which, from a database storing data of a plurality of items classified as a plurality of classes, a combination of items characteristically included in one of the classes is output as a feature pattern of that class. Specifically, the present invention relates to a feature-pattern output apparatus, a feature-pattern output method, and a feature-pattern output program that allows the feature pattern to be output at high speed even if the database is large.

2) Description of the Related Art

In recent years, schemes for extracting, from data stored in a database, a correlation among the data and rules of the data have been devised. Such a correlation among the data and rules of the data can be used to classify the data already stored in the database and new data.

Conventionally-published correlation rule learning schemes of extracting rules from a database for feedback to the database include Agrawel, R., “Fast Algorithm for Mining Association Rules” and its corresponding patent document of “system and method for mining successive pattern inside large-scale database” (Japanese Patent Laid-Open Publication No. 8-263346).

According to the scheme published in the documents described above, data elements called items are combined to form a pattern, and a data correlation rule is represented by a frequently-appearing pattern.

In this scheme, however, a high cost is required for extracting the correlation rule, and when the contents of the database are changed, some time is required until the correlation rule is applied according to the change. Therefore, extraction of the correlation rule is often performed offline, thereby impairing followability to the update of the database.

Furthermore, a processing time required for extracting a correlation rule and classifying the data based on the extracted correlation rule greatly varies depending on the setting of parameters. Moreover, the obtained correlation rule itself greatly depends on the parameters. That is, to appropriately set the parameters, expert knowledge and experience are required. Depending on the setting of the parameters, usability of the obtained rule may be decreased, or the processing time may become too long to perform the operation of the correlation rule.

Also, another example of a rule extracting scheme published is J. Li, G. Dong, K. Ramamohanarao, and L. Wong., “DeEPs: A new instance-based discovery and classification system”, Technical report, Dept of CSSE, University of Melbourne, 2000. In DeEPs published in this report, upon provision of input data, pattern finding of. learning an applicable pattern is possible on a real-time basis. Therefore, the database can be updated at an arbitrarily timing without being placed offline. Also, in DeEPs, pattern finding does not require parameter setting, and therefore less expert knowledge and experience are required for operation.

However, in DeEPs, all pieces of data in the database are required to be processed in finding a pattern. Thus, a high processing capability is required depending on the number of pieces of data included in the database. Therefore, if the number of pieces of data is large, a time required for a pattern extracting process is too long to be allowable as a response time in a real-time processing.

Moreover, in DeEPs, a processing time is required in proportion to the number of items, which are elements of data. Therefore, when the number of items included in each piece of data is large, an enormous amount of time is required for a pattern extracting processing.

### SUMMARY OF THE INVENTION

It is an object of the present invention to solve at least the above problems in the conventional technology.

A feature-pattern output apparatus according to one aspect of the present invention, which has a database in which data formed of a plurality of items is classified as a plurality of classes, and outputs a combination of items forming a feature of each of the classes as a feature pattern of the class, includes a similar-data extracting unit that extracts, when input data is received, similar data that is similar to the input data for each of the classes from the database; a similar-pattern-set calculating unit that calculates a similar pattern set for each of the classes from the similar data extracted; and a feature-pattern calculating unit that calculates a feature pattern for each of the classes from the similar pattern set calculated.

A feature-pattern output method according to another aspect of the present invention, which is for outputting, from a database in which data formed of a plurality of items is classified as a plurality of classes, a combination of items forming a feature of each of the classes as a feature pattern of the class, includes extracting, when input data is received, similar data that is similar to the input data for each of the classes from the database; calculating a similar pattern set for each of the classes from the similar data extracted; and calculating a feature pattern for each of the classes from the similar pattern set calculated.

A computer-readable recording medium according to still another aspect of the present invention stores a feature-pattern output program that causes a computer to execute the above feature-pattern output method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a structural diagram schematically depicting a feature-pattern output apparatus according to a first embodiment of the present invention;

FIGS. 2A and 2B are drawings of a specific example of input data and similar data;

FIG. 3 is a drawing of a data space with data groups being arranged according to their degrees of similarity;

FIGS. 4A and 4B are drawings of a maximum pattern set and a minimum pattern set;

FIG. 5 is a drawing of a process of a feature-pattern-set calculating unit;

FIG. 6 is a flowchart for explaining a process of an input data classifying unit 36;

FIG. 7 is a drawing for explaining a statistical examining process for eliminating an attribute noise;

FIG. 8 is a drawing of a relation between data and a degree of similarity according to a second embodiment;

FIGS. 9A and 9B are drawings of a maximum pattern set and a minimum pattern set according to the second embodiment;

FIG. 10 is an explanatory diagram for explaining a computer system according to a third embodiment; and

FIG. 11 is an explanatory diagram for explaining the structure of a main body unit shown in FIG. 10.

### DETAILED DESCRIPTION

With reference to the attached drawings, exemplary embodiments of the feature-pattern output apparatus, the feature-pattern output method, and the feature-pattern output program are described in detail below.

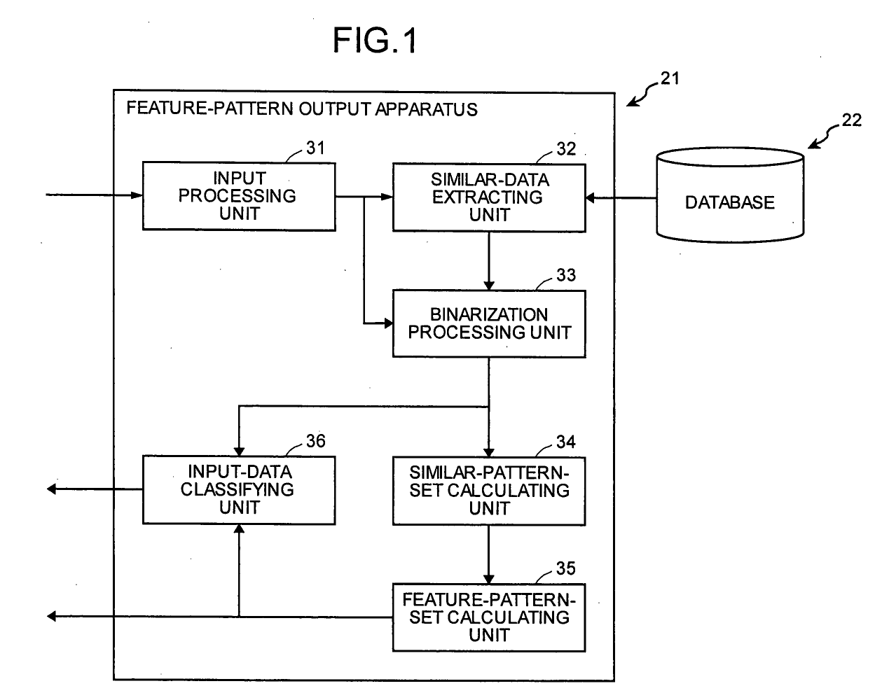

FIG. 1 is a structural diagram schematically depicting a feature pattern apparatus according to a first embodiment of the present invention. In FIG. 1, a feature-pattern output apparatus 21 is connected to a database 22. The database 22 stores information about clients with each piece of data corresponding to one of the clients. Also, the data includes item names, such as “age”, “home”, “sex”, and “marriage”. Each piece of data has a value for each item name. Hereinafter, a combination of an item name and its value is referred to as an item. The database 22 classifies the clients, that is, the data, by whether credit is approved. In the database 22, clients whose credit is “approved” are classified as a “class P”, while clients whose credit is “disapproved” are classified as a “class N”.

The feature-pattern output apparatus 21 includes an input processing unit 31, a similar-data extracting unit 32, a binarization processing unit 33, a similar-pattern-set calculating unit 34, a feature-pattern-set calculating unit 35, and an input data classifying unit 36. Upon receipt of client information as input data, the input processing unit 31 outputs the input data to the similar-data extracting unit 32 and the binarization processing unit 33.

The similar-data extracting unit 32 extracts data similar to the input data for output as similar data to the binarization processing unit 33. Based on the input data, the binarization processing unit binarizes the similar data, and then transmits the resultant data to the similar-pattern-set calculating unit 34 and the input data classifying unit 36.

The similar-pattern-set calculating unit 34 calculates, based on the binarized similar data, a similar pattern set for each of the class P and the class N. The feature-pattern-set calculating unit 35 outputs, from out of the similar pattern set, a combination of items characteristically appearing for each of the class P and the class N as a feature pattern.

Furthermore, the input data classifying unit 36 compares the binarized similar data and the feature pattern to determine whether the input data is classified as the class P or the class N.

The feature-pattern output apparatus 21 outputs these feature patterns and the results of classification of the input data. That is, the feature-pattern output apparatus 21 extracts data similar to the input data from the database 22, and then calculates a feature pattern from the similar data. Therefore, feature pattern calculation can be performed at high speed without depending on the number of pieces of data in the database 22 or the number of items in each data.

Next, each process is described in detail by using a specific example.

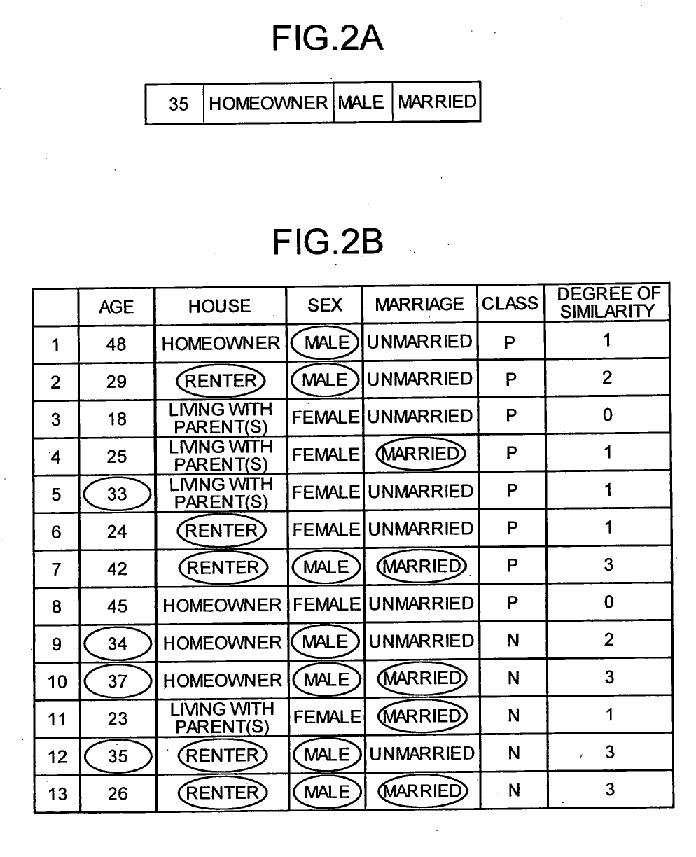

FIGS. 2A and 2B are drawings of a specific example of the input data and the similar data. FIG. 2A indicates an example of the input data, while FIG. 2B indicates an example of the data stored in the database 22. As shown in FIGS. 2A and 2B, the input data has “35” as “age”, “renter” as “home”, “male” as “sex”, and “married” as “marriage”.

The similar-data extracting unit 32 adopts a function using the City-block distance as a similarity function to extract similar data from the database 22.

Specifically, when n is the number of items, X is the data stored in the database 22, and Y is the input data,

$$Sim ( X , Y ) = {\sum }_{i = 1}^{n} δ ( 〈 {f}_{i} : {x}_{i} 〉 , 〈 {f}_{i} : {y}_{i} 〉 ) , \\ where δ ( 〈 {f}_{i} : {x}_{i} 〉 , 〈 {f}_{i} : {y}_{i} 〉 ) = \{ \begin{matrix}1 & if {x}_{i} = {y}_{i} ( discrete attribute ) \\ & or {x}_{i} ∈ [ {y}_{i} - α , {y}_{i} + α ] \\ & ( numerical attribute ) \\ 0 & if {x}_{i} \neq {y}_{i} ( discrete attribute ) \\ & or {x}_{i} ∉ [ {y}_{i} - α , {y}_{i} + α ] \\ & ( numerical attribute )\end{matrix} \\ X = \{ 〈 {f}_{1} : {x}_{1} 〉 , … 〈 {f}_{n} : {x}_{n} 〉 \} , y = \{ 〈 {f}_{1} : {x}_{1} 〉 , … 〈 {f}_{n} : {x}_{n} 〉 \}$$

Here, the item <fi:xi> represents that the item name “fi” has a value of “xi”. Also, as for an item having a numerical value as the item name, such an item is normalized in a [0, 1] section, and a is defined as a radius of 0 to 1. That is, 6 is 1 when the item is present within the radius α of the input data, while δ is 0 when the item is present outside of the radius α.

That is, this similarity function calculates the number of items in the data stored in the database that coincide with the items included in the input data. In FIG. 2B, items in each piece of data that coincide with the input data are circled, and an output of the similarity function is represented by a degree of similarity. Here, “age” is numerical data and, with a margin of 5 corresponding α=0.18 being allowed, it is determined that items coincide with each other when their age is within 30 to 40.

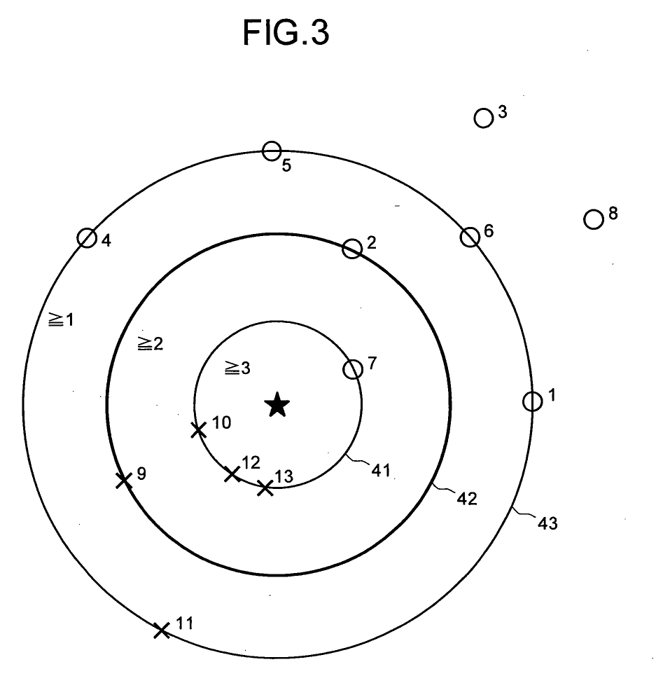

Furthermore, a data space with data groups shown in FIG. 2B being arranged according to their degrees of similarity is shown in FIG. 3. In FIG. 3, the input data is represented by a black star, pieces of data belonging to the class P are each represented by a circle, pieces of data belonging to the class N are each represented by a cross. Here, a number near each symbol represents a data number in FIG. 2B.

As shown in FIG. 3, data 7, 10, 12, and 13 with their degree of similarity of 3 are most close to the input data and are present on a cocentric circle 41. Also, data 2 and 9 with their degree of similarity of 2 are present on the next cocentric circle 42. Furthermore, data 1, 4, 5, 6, and 11 with their degree of similarity of 1 are present on the next cocentric circle 43, and data 3 and 8 with their degree of similarity of 0 are present outside of the cocentric circle 43.

The similar-data extracting unit 32 extracts data having a degree of similarity equal to or larger than a predetermined threshold as the similar data or extracts a predetermined number of pieces of data, for example, five pieces of data, in the order in which the degree of similarity is higher, as the similar data. Here, all pieces of data having the same degree of similarity are included in the similar data. Therefore, in FIG. 3, six pieces of data, that is, the data 7, 10, 12, and 13 with their degree of similarity of 3 and the data 2 and 9 with their degree of similarity of 2, are extracted as the similar data..

The binarization processing unit 33 performs a binarization process on the similar data extracted by the similar-data extracting unit 32. Specifically, items with δ=0 are excluded from the similar data, and the value of the item name with δ=1 is replaced by the value of the same item name in the input data. Here, the value of the item name of a discrete attribute is identical to that of the input data. Therefore, by rewriting the value of the item name of the numerical attribute with the value of the item name of the input data, the similar data can be binarized.

Therefore, as the result of binarization, the following similar data is obtained.
Data 2 {<house: renter><sex: male>}
Data 7 {<house: renter><sex: male><marriage: married>}
Data 9 {<age: 35><sex: male>)
Data 10 {<age: 35><sex: male><marriage: married>)
Data 12 {<age: 35><house: renter><sex: male>)
Data 13 {<house: renter><sex: male><marriage: married>}

With the similar data being binarized in the manner as described above, of the items included in the similar data, only the items also included in the input data are left. Therefore, feature pattern calculation can be performed only by calculating an item set.

The similar-pattern-set calculating unit 34 calculates a maximum pattern set and a minimum pattern set for each of the class P and the class N. The maximum pattern set is a set of items for which no upper set is present in the similar data of the class. The minimum pattern set is a set of items for which no subset is present in the similar data of the class.

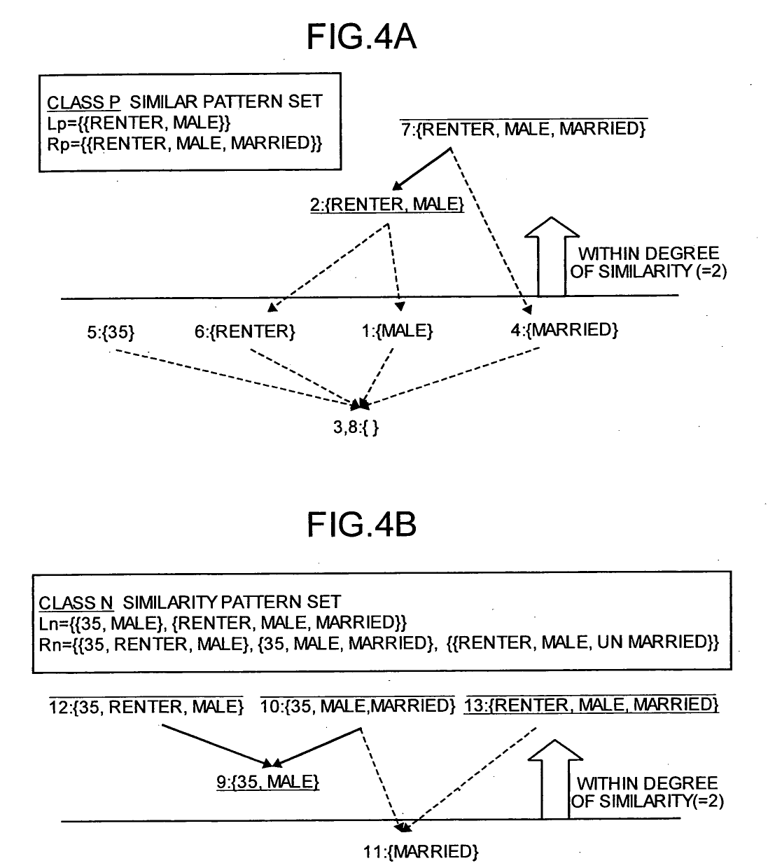

FIGS. 4A and 4B depict the maximum pattern set and the minimum pattern set. FIG. 4A is a drawing that depicts an inclusion relation of the sets in the class P, while FIG. 4B is a drawing that depicts an inclusion relation of the sets in the class N.

Here, as for the class P,
Data 2 (<house: renter><sex: male>), and
Data 7 (<house: renter><sex: male><marriage: married>).
   Also, all items of the data 2 are included in the data 7. That is, the data 2 is a subset of the data 7, and the data 7 is an upper set of the data 2. This relation is represented by a solid arrow in the FIG. 4A.

Here, no upper set of the data 7 is present in the similar data of the class P. Therefore, the data 7 is a maximum pattern set of the class P. On the other hand, the data 1 and 6 are subsets of the data 2. However, the data 1 and 6 have the degree of similarity of 1, and are not selected as the similar data. That is, no subset of the data 2 is present in the similar data of the class P. Therefore, the data 2 is a minimum pattern set of the similar data of the class P.

Similarly, as for the class N,
Data 9 {<age: 35><sex: male>),
Data 10 {<age: 35><sex: male><marriage: married>),
Data 12 {<age: 35><house: renter><sex: male>), and
Data 13 {<house: renter><sex: male><marriage: married>}.
   Also, all items of the data 9 are included in the data 10 and 12. That is, the data 9 is a subset of both of the data 10 and 12, and the data 10 and 12 are upper sets of the data 9. This relation is represented by solid arrows in FIG. 4B.

Here, no upper set of the data 10 and 12 is present in the similar data of the class N. Therefore, the data 10 and 12 are maximum pattern sets of the class N. Also, no subset of the data 9 is present in the similar data of the class N. Therefore, the data 9 is a minimum pattern set of the class N.

As for the data 13, no upper set or subset is present in the similar data of the class N. Therefore, the data 13 is a maximum pattern set of class N and also a minimum pattern set thereof.

Here, in the class P, Dp is the binarized similar data, Lp is the minimum pattern set, and Rp is the maximum pattern set, a pattern set [Lp, Rp] represents patterns serving as upper sets of at least one minimum pattern and subsets of at least one maximum pattern.

Therefore,
Dp⊂[Lp, Rp]
holds.

In the data shown in FIG. 4A, Lp={{renter, male}}, Rp={{renter, male, married}}, and Dp={{renter, male}},{renter, male, married}}.

Similarly, in the class N, Dn is the binarized similar data, Ln is the minimum pattern set, and Rn is the maximum pattern set, a pattern set [Ln, Rn] represents patterns serving as upper sets of at least one minimum pattern and subsets of at least one maximum pattern.

Therefore,
Dn⊂[Ln, Rn]
holds.

In the data shown in FIG. 4B, Ln={{35, male},{renter, male, married)), Rn={{35, renter, male}, {35, male, married}, {renter, male, married}}, and Dn={{renter, male}}, {35, renter, male}, {35, male, married), {renter, male, married}}.

In the example shown in FIG. 4A, Dp=[Lp, Rp]. However, the pattern serving as an upper set of the minimum pattern and a subset of the maximum pattern is included in [Lp, Rp] even if not being present in the similar data, that is, being a pattern that is not present in Dp.

Here, <L, R> is defined as a border of a minimum pattern L and a maximum pattern R. The border <L, R> represents a pattern set [L, R] as a pair of the minimum pattern and the maximum pattern. Therefore, by using the border, a set calculation can be replaced by a calculation targeted only for the maximum pattern and the minimum pattern without directly handling elements of sets. This can make calculation significantly efficient.

The similar-pattern-set calculating unit 34 outputs the border <Lp, Rp> and a border <Ln, Rn> as a similar pattern set to the feature-pattern-set calculating unit 35, and then ends the process.

First, when Rp and Rn represent maximum patterns of the class P and the class N, respectively, for all pieces of data, it has been proved that [{φ}, Rp]-[{φ}, Rn] represents a pattern set including all patterns appearing only in the class P (J. Li and K. Ramamohanarao, “The space of jumping emerging patterns and its incremental maintenance algorithm”, In proceedings of 17th International Conference on Machine learning, pages 551-558, Morgan Kaufmann, 2000).

According to the present invention, as for Rp and Rn, the target for process is data similar to the input data. Also, Rp and Rn are not guaranteed to be the maximum pattern for the entire data. However, since the similar data has a high degree of similarity, the number of items coinciding with the items of the input data is large. Furthermore, the maximum pattern usually has many items. Therefore, there is a high possibility that the maximum pattern is included in the similar pattern.

However, even if many maximum patterns are included, there is a possibility that any maximum pattern may fail to be detected. Even with one maximum pattern failing to be detected, an erroneous feature pattern may possibly be found. Such an erroneous feature pattern causes a degradation in accuracy of classification. Therefore, to calculate a feature pattern from the similar data, a condition is added in which the number of items of the similar data is larger than those of the pattern commonly appearing in the class P and the class N, thereby preventing any maximum pattern from failing to be detected and also preventing a degradation in classification accuracy.

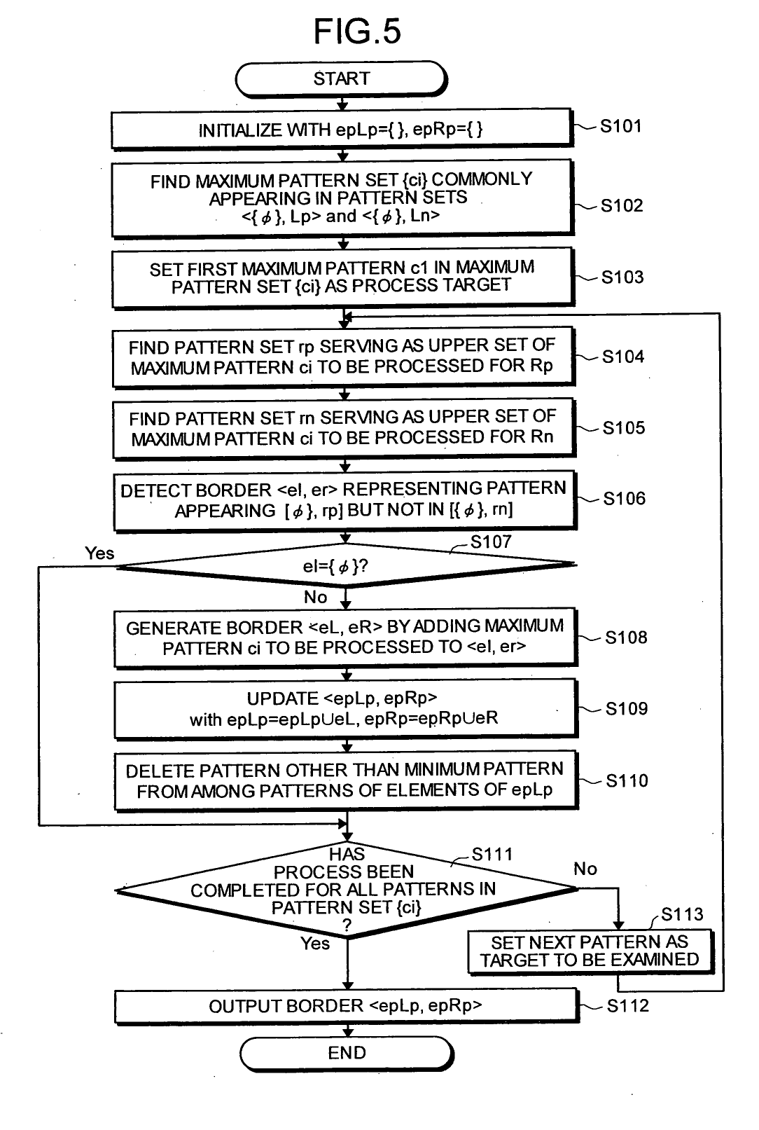

The operation of the feature-pattern-set calculating unit 35 is shown in FIG. 5. In FIG. 5, the feature-pattern-set calculating unit 35 finds a pattern set commonly appearing in pattern sets [{φ}, Lp] and [{φ}, Ln] from the similar pattern sets <Lp, Rp> and <Ln, Rn>. Specifically, firstly, epLp and epRp, which will be output data, are initialized as epLp={} and epRp={56 . Next, intersecOperation(<{φ}, Lp>, <{φ}, Ln>) is used to calculate <{φ}, {c1, . . . ck}> (step S102). This intersecOperation is the same as shown in the document described above, wherein, with all patterns commonly appearing in both of the sets represented by two borders <{φ, Lp>, <{φ}, Ln> are output in a form of the border <{φ}, {c1, . . . ck}>.

That is, through this process, a set of maximum patterns (c1, . . . ck} commonly appearing in both of the pattern sets [{φ}, Lp] and [{φ}, Ln] can be obtained. An arbitrary ci included in {c1, . . . ck} is a common maximum pattern. Thus, an upper set of ci:
appears only in the data of the class P;
appears only in the data of the class N; or
appears in neither the class P nor the class N.

Therefore, for each element ci in {c1, . . . ck}, a pattern including ci and not appearing only in the class P and not in the class N is found, thereby obtaining a set of patterns characteristically appearing in the class P.

Thus, after finding {c1, . . . ck}, the feature-pattern-set calculating unit 35 sets a first pattern c1 as a target to be processed (step S103), and then finds, in the maximum pattern set Rp of the class P, a pattern set rp serving as an upper set of the common pattern to be processed (step S104). Then, the feature-pattern-set calculating unit 35 finds, in the maximum pattern set Rn of the class N, a pattern set rn serving as an upper set of the common pattern to be processed (step S105).

Next, the feature-pattern-set calculating unit 35 finds a pattern set appearing in a pattern set [{φ}, rp] but not in a pattern set [{φ}, rn]. Specifically, jepProducer(<{φ}, rp>, <{φ}, rn>) is used to calculate <el, er> (step S106). This jepProducer is the same as shown in the document described above, wherein, with a pattern set appearing in the pattern set [{φ}, rp] represented by the border <{φ}, rp> but not in the pattern set [{φ}, rn] represented by the border <{φ}, rn> is output in a form of the border <el, er>.

Here, if el is not {φ} (No at step S107), the feature-pattern-set calculating unit 35 adds a common pattern to be processed to <el, er> to generate a border <eL, eR> (step S108). The pattern set represented by this border <eL, eR> is an upper set of the common pattern to be processed, and therefore is a pattern set appearing in the class P and but in the class N.

The feature-pattern-set calculating unit 35 adds this border <eL, eR> to a border <epLp, epRp> (step S109). The border <epLp, epRp> is data to be eventually output as a feature pattern. Here, monitoring is performed so that epLp includes only the minimum pattern as an element and a pattern other than the minimum pattern is excluded (step S110).

After step S110 is completed or when el is {φ} (Yes at step S107), the feature-pattern-set calculating unit 35 determines whether the process has been completed for all elements of the pattern set {c1, . . . ck} (step S111). If an element not yet been processed is present (No at step S111), the feature-pattern-set calculating unit 35 sets the next element as a target to be processed (step S113), and then goes to step S104.

On the other hand, if the process has been completed for all elements (Yes at step S111), the feature-pattern-set calculating unit 35 outputs the border <epLp, epRp> (step S112).

Also, the feature-pattern calculating unit 35 can also calculate a border <epLn, epRn> for the class N. The feature-pattern calculating unit 35 uses these <epLp, epRp> and <epLn, epRn> to output a feature pattern set SEP, where SEP=epLp∪epLn. This feature pattern SEP is a logical sum of minimum patterns characteristically appearing in the class P or the class N. The feature-pattern calculating unit 35 outputs the feature pattern set SEP to the outside of the feature-pattern output apparatus 21 and also to the input data classifying unit 36.

Here, it is assumed that the process of the feature-pattern calculating unit 35 is applied to the data shown in FIGS. 4A and 4B. Firstly, the minimum pattern set of the class P is Lp={{renter, male}}, and the minimum pattern set of the class N is Ln={{35, male}, {renter, male, married}. Therefore, the pattern set commonly appearing in the classes is {{renter, male}} (step S102).

Therefore, the following process continues with ci={renter, male} (step S102).

In the class P, in the maximum pattern set Rp of the class P={{renter, male, married}}, an upper set of ci={renter, male} is rp={{renter, male, married}} (step S103). Similarly, in the class N, in the maximum pattern set Rn={{35, renter, male), {35, male, married}, {renter, male, married}}, an upper set of ci={renter, male}} is rn={{35, renter, male}, {renter, male, married}} (step S104).

A pattern set appearing in the found [{φ}, rp] but not in [{φ, rn] is found by using jepProducer(<{φ}, rp>, <{φ}, rn>), and the found result is <el, er>=<{φ},{φ}> (step S105).

Only one element is present in the maximum common pattern set {ci}. Consequently, in this example, only the feature pattern of the class P is <epLp, epRp>=<{φ}, {φ>.

On the other hand, as for the class N, the result obtained up to step S104 is the same as that as for the class P, that is, ci={{renter, male}}, rn={{35, renter, male}, {renter, male, married}}, and rp={renter, male, married}} (steps S101 to S104).

A pattern set appearing in the found [{φ}, rn] but not in [{φ}, rp] is found by using jepProducer(<{φ}, rn>, <{φ}, rp>), and the found result is <el, er>=<{35},{35, renter, male}> (step S105). A border obtained by adding ci to each of el and er is <eL, eR>=<{35, renter, male), (35, renter, male)> (step S106). Only one element is present in the maximum common pattern set (c1). Consequently, in this example, only the feature pattern of the class N is <epLn, epRn>=<(35, renter, male}, {35, renter, male}> (steps S107 to S110).

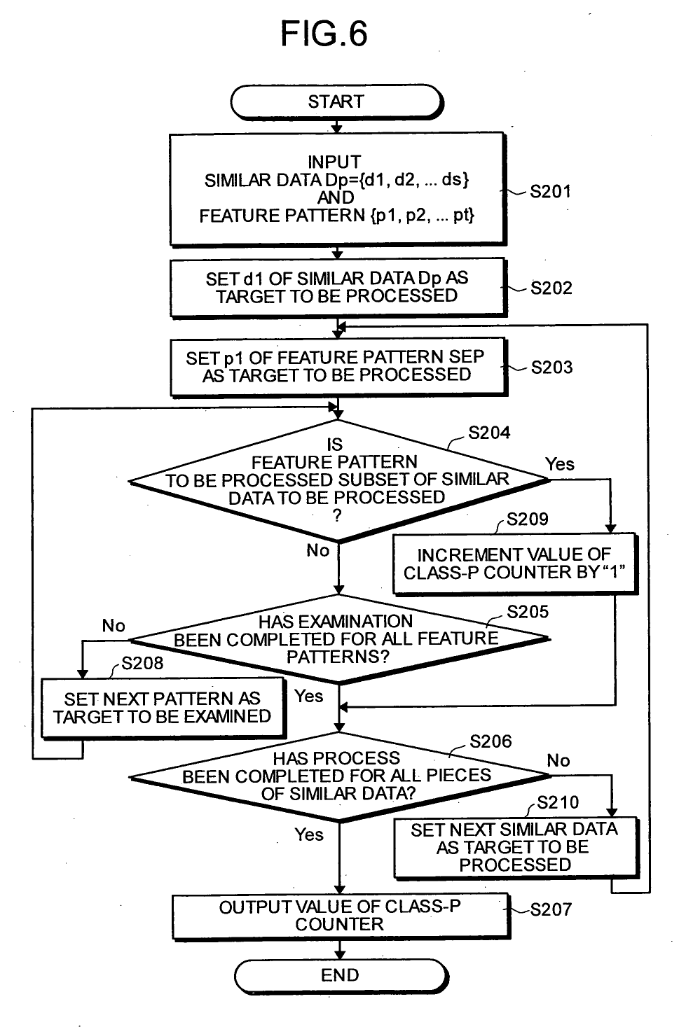

Next, the operation of the input data classifying unit 36 is described. FIG. 6 is a flowchart for explaining a process of the input data classifying unit. 36. In FIG. 6, the input data classifying unit first obtains, as input data, binarized similar data of the class P, that is, Dp={d1, d2, . . . ds} and a feature pattern SEP={p1, p2, . . . pt} (step S201).

Then, the input data classifying unit 36 sets d1, which is the first element of the similar data Dp, as a target to be processed (step S202). Furthermore, the input data classifying unit 36 sets p1, which is the first element of the feature pattern SEP, as a target to be processed (step S203).

The input data classifying unit 36 checks to see whether the feature pattern to be checked is a subset of the similar data to be processed (step S204). If the feature pattern to be checked is a subset of the similar data to be processed (Yes at step S204), the input data classifying unit 36 increments a class-P counter by one (step S209).

On the other hand, if the feature pattern to be checked is not a subset of the similar data to be processed (No at step S204), the input data classifying unit 36 determines whether checking has been completed for all feature patterns (step S205). If a feature pattern not yet checked is present (No at step S205), the input data classifying unit 36 sets the next feature pattern as a target to be checked (step S208), and then goes to step S204.

If all feature patterns have been checked (Yes at step S205) or after the class-P counter is incremented, the input data classifying unit 36 determines whether a process has been performed for all pieces of similar data (step S206). If a piece of similar data not yet checked is present (No at step S206), the input data classifying unit 36 sets the next piece of similar data as a target to be processed (step S210), and then goes to step S203.

On the other hand, if all pieces of similar data have been processed (Yes at step S206), the input data classifying unit 36 outputs the value of the class-P counter, and then ends the process. With this process, the input data classifying unit 36 can count the number of pieces of similar data including any feature pattern SEP in the similar data belonging to the class P. That is, the value of the class-P counter represents the number of pieces of data matching with one or more feature patterns of the similar data belonging to the class P.

Also, the input data classifying unit 36 performs a process similar to the process described above to output a value of a class-N counter. The value of the class-N counter represents the number of pieces of data matching with one or more feature patterns of the similar data belonging to the class N. The input data classifying unit 36 compares the value of the class-P counter and the value of the class-N counter, and then classifies the input data as the class having a value larger than that of the other.

As described above, in the feature-pattern output apparatus 21 of the first embodiment, data similar to the input data is extracted from the database 22, a maximum pattern set and a minimum pattern set are calculated from this similar data for each class, and then a feature pattern is calculated from the maximum pattern set and the minimum pattern set for each class. Therefore, feature pattern calculation can be performed at high speed without depending on the number of pieces of data in the database 22 or the number of items in each data. As a result, the input data can be easily classified by using the calculated feature pattern.

Furthermore, the feature pattern is calculated from the data similar to the input data. Therefore, even a local feature pattern can be detected with high accuracy.

When similar data is extracted based on the input data, noise may occur in the similar data. To get around this problem, a noise eliminating mechanism is added to the similar-data extracting unit 32. This can improve accuracy in detecting the feature pattern and accuracy in classifying the input data.

Such noise occurring in the similar data includes a class noise caused when similar data of a predetermined class is mixed with data of another class and an attribute noise caused when an item of predetermined similar data is replaced by another item.

When a class noise is present, in the binarized similar data, the same maximum pattern may appear in both of the class P and the class N. If the same maximum pattern appears in both of the class P and the class N, even a single feature pattern cannot be found, and also the classification accuracy is significantly degraded. To get around these problems, if the same pattern appears in both of the class P and the class N, the pattern is excluded from each of the classes, and a subset of the excluded pattern is newly included, thereby suppressing the occurrence of a class noise.

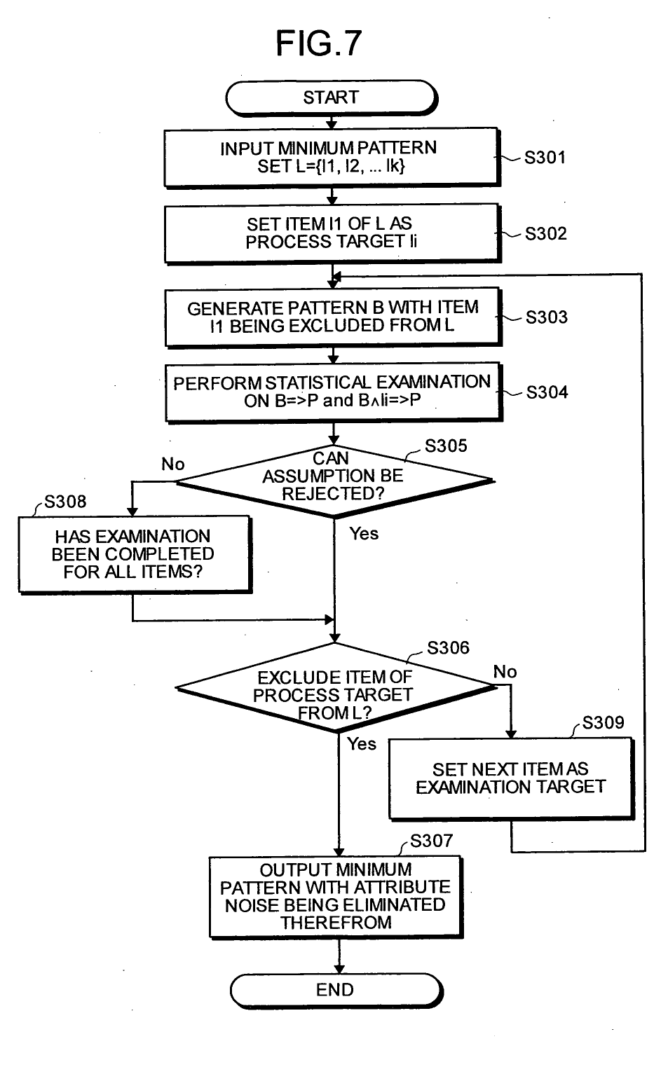

As for the attribute noise, a statistical examining process shown in FIG. 7 is used to eliminate the attribute noise. As shown in FIG. 7, in this attribute noise elimination, L, which is one of the minimum patterns, is firstly input (step S301). Here, items included in L are taken as I1, I2, . . . Ik, L={I1, I2, . . . Ik}.

Next, the first item I1 of L is set as a process target Ii (step S302). Next, a pattern B with the item of the process target being excluded from Lp is generated (step S303). Then, statistical examination is performed on B=>P and B\hat{ }Ii=>P (step S304). It is determined whether addition of the item to the pattern B through this examination can be regarded as being statistically accidental. If such addition cannot be regarded as being statistically accidental, the item Ii is considered as appearing due to an attribute noise.

Specifically, in the statistical examining process, a statistical assumption that no difference in probability distribution between B=>P and B\hat{ }Ii=>P is established, and whether this assumption can be rejected is examined by using the following equation
T=(S_{LP}S_{L}-S_{L}S_{BP})/(S_{L}S_{BP}(S_{B}-S_{BP})/N)^{1/2}
where S_{B} is the number of pieces of data matching with the pattern B, S_{L} is the number of pieces of data that match with the pattern B\hat{ }Ii, S_{BP} is the number of pieces of data of the class P that match with the pattern B, and S_{LP} is the number of pieces of data belonging to the class P that match with the pattern B\hat{ }Ii.

It is known that this T follows a normal distribution. When a level of significance is taken as a, z(a/2) is a value of a density function of p(z)=a/2 of the normal distribution. If T÷z(a/2), it is assumed that no statistical difference between B=>P and B\hat{ }Ii=>P is present. Thus, Ii is handled as accidentally appearing and is excluded from the pattern set Lp.

Therefore, in FIG. 7, as a result of statistical examination, it is determined the assumption can be rejected (step S305). If the assumption cannot be rejected (No at step S305), the item Ii to be processed is excluded from L as an attribute noise (step S308), and the procedure then goes to step S306.

On the other hand, if the assumption can be rejected (Yes at step S305), it is determined whether examination has been completed for all items (step S306). If an item not yet examined is present (No at step S306), the next item is set to an examination target (step S309), and the procedure then goes to step S303.

If all items have been processed (Yes at step S306), a minimum pattern L with the attribute noise being eliminated therefrom is output (step S307), and then the procedure ends.

As such, by providing the similar-data extracting unit 32 with a function of eliminating a class noise and an attribute noise, accuracy in detecting the feature pattern and accuracy in classifying the input data can be improved.

Next, a second embodiment of the present invention is described. According to the first embodiment, when similar data is extracted from the database 22, a single predetermined threshold is set, and data having a degree of similarity equal to or larger than the threshold is extracted. According to the second embodiment, a threshold is set for each of the data of the class P and the data of the class N, and similar data is extracted for each class. Here, when similar data is extracted so that the number of extracted pieces of data satisfies a predetermined number, the predetermined number is set for each of the class P and the class N, and then similar data is extracted for each of the class P and the class N.

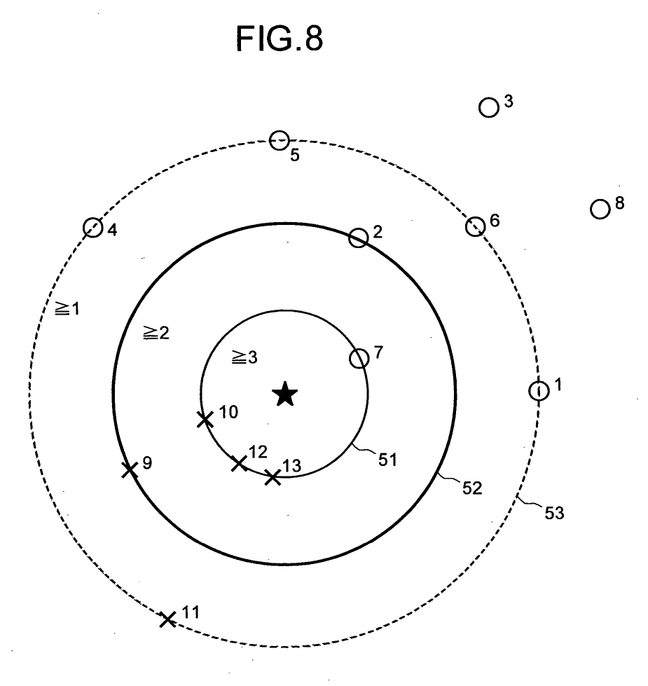

FIG. 8 depicts a relation between the data and the degree of similarity according to the second embodiment. The arrangement of the data 1 to 13 is similar to that of FIG. 3. Similarly to FIG. 3, a cocentric circle 51 represents a degree of similarity of 3, a cocentric circle 52 represents a degree of similarity of 2, and a cocentric circle 53 represents a degree of similarity of 1. However, FIG. 8 is different from FIG. 3 in that the cocentric circle 53 represents a threshold for the data of the class P, while the cocentric circle 52 represents a threshold for the data of the class N.

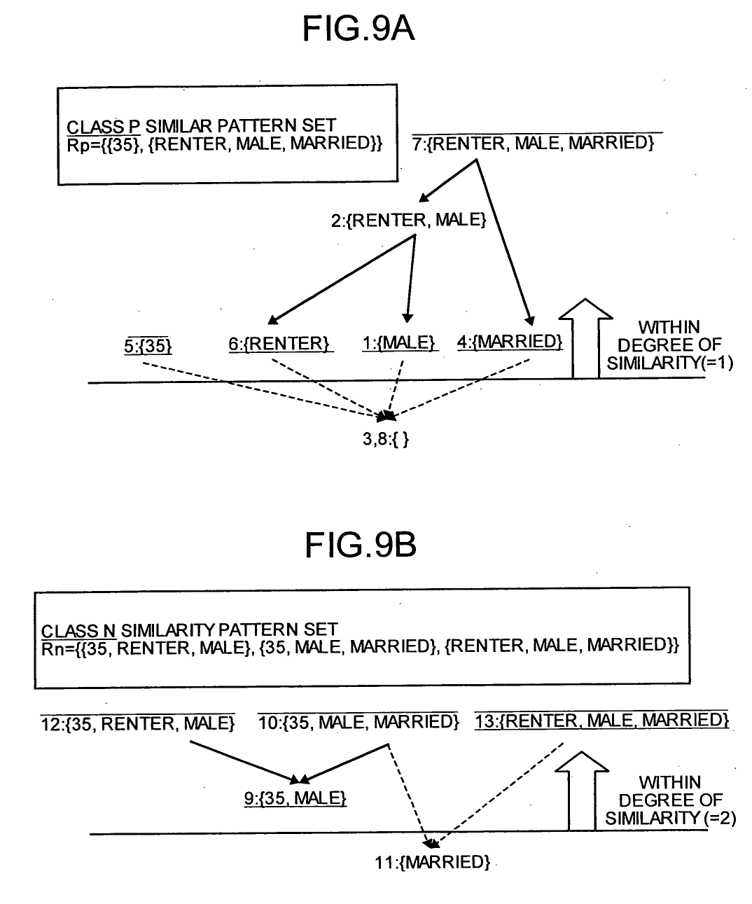

As for the class P, since the threshold of the degree of similarity is decreased to 1, as shown in FIG. 9A, the data 1, 4, 5, and 6 are newly extracted as similar data. Here, the data 1 and 6 are subsets o the data 2, and the data 4 is a subset of the data 7. However, since the data 5, does not have its upper set, the data 5 is a maximum pattern of the class P. Therefore, Rp according to the second embodiment further includes {35} corresponding to the data 5 to be {{35}, {renter, male, married}. Here, as shown in FIG. 9B, since the threshold of the class N is 2, the similar patterns of the class N are not changed.

According to the first embodiment, it has been proved that all feature patterns can be calculated if all maximum patterns are obtained from all pieces of data. As is the case of the present invention, when only the data near the input data is handled, it is required to add a condition in which, for calculation of a feature pattern from the similar data, the number of items of the similar data is larger than those of the pattern appearing in both of the class P and the class N, thereby preventing a maximum pattern from failing to be detected and also preventing a degradation in classification accuracy.

Therefore, by setting threshold for each class and obtaining a sufficient number of samples from all classes, a degradation in classification accuracy because of failing to detect a maximum pattern can be prevented.

A process of binarizing the similar data and a process of calculating a similar pattern set are similar to those according to the first embodiment, and therefore are not described herein. However, the similar pattern set according to the second embodiment uses data near the input data for each class and approximates to the entire data included in the database 22. Therefore, in a process of calculating a feature pattern, the jetProducer described above is used to calculate <epLp, epRp> by
<epLp, epRp>=jepProducer(<{φ}, Rp>, <{φ}, Rn>).
Therefore, in the present embodiment, the minimum pattern sets Rp and Rn are not used, and the feature pattern can be calculated from the maximum pattern sets Lp and Ln. the feature pattern is compared between the similar data of the class P and the similar data of the class N. However, the method of classifying the input data is not meant to be restricted to this method. The input data can be classified by using another evaluation criteria or combinations thereof.

As the evaluation criteria that can be used for classification of the input data, the number of feature patterns and the number of items in the feature pattern can be used, for example. When the number of feature patterns is used, evaluation is high when the number of appearance of the feature pattern is large. When the number of items of the feature pattern is used, evaluation is high when the number of items is large.

Specifically, when the number of feature patterns is used, a sum of the sizes of the feature patterns belonging to epLp and a sum of the sizes of the feature patterns belonging to epLn are compared, and the input pattern is classified as the pattern having a value larger than that of the other.

According to a third embodiment of the present invention, a computer system that executes a feature-pattern output program having the same functions as those of the feature-pattern output apparatuses described in the first and second embodiments is described.

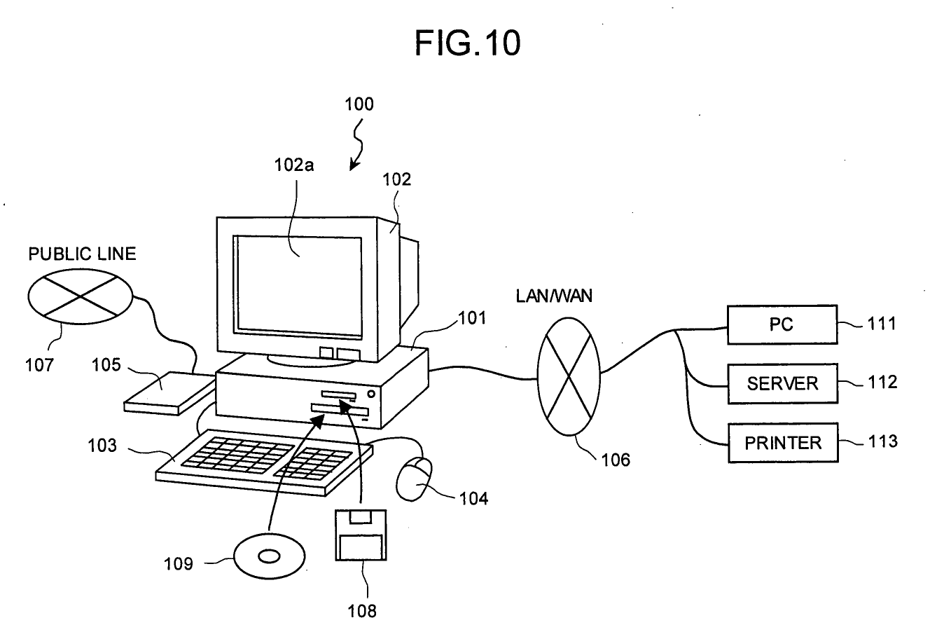

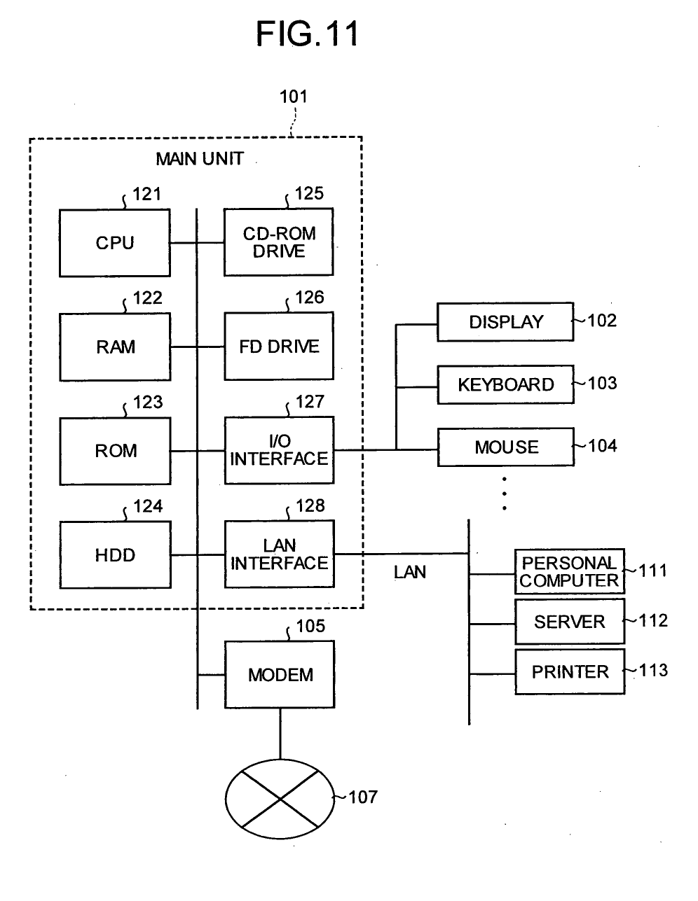

A computer system 100 shown in FIG. 10 includes a main body unit 101, a display 102 that displaying information, such as images, on a display screen 102 a upon instruction from the main body unit 101, a keyboard 103 for inputting various information to this computer system 100, a mouse 104 that specifies an arbitrary position on the display screen 102a of the display 102, a local-area-network (LAN) interface connected to a LAN 106 or a wide area network (WAN), and a modem 105 connected to a public line 107, such as the Internet. Here, the LAN 106 connects the computer system 100 and another computer system (PC) 111, a server 112, a printer 113, and others together. Also, as shown in FIG. 11, the main body part 101 includes a CPU 121, RAM 122, ROM 123, a hard disk drive (HDD) 124, a CD-ROM drive 125, an FD drive 126, an I/O interface 127, and a LAN interface 128.

When a data managing method is performed in this computer system 100, a feature-pattern output program stored in a storage medium is installed on the computer system 100. The installed feature-pattern output program is stored in the HDD 124, and is executed by using the RAM 122 and the ROM 123, for example. Here, the storage medium may be a portable storage medium, such as a CD-ROM 109, a floppy disk 108, a DVD disk, a magneto-optical disk, or an IC card; a storage device, such as the hard disk 124, provided inside or outside of the computer system 100; a database of the server 112 retaining a data managing program of an install source connected via the LAN 106; the other computer system 111 or its database; or a transmission medium on the public line 107.

As described above, according to the third embodiment, a feature-pattern output program implementing the structure of the feature-pattern output apparatus described in the first and second embodiments by software is executed on the computer system 100. With this, effects similar to those of the feature-pattern output apparatus described in the first and the second embodiments can be achieved by using a general computer system.

According to the present invention, similar data that is similar to the input data is extracted from the database, and a feature pattern characteristic for each class is calculated from the extracted similar data. This makes it possible to achieve an effect of providing a feature-pattern output apparatus, a feature-pattern output method, and a feature-pattern output program allowing the feature pattern to be output at high speed irrespectively of the size of the database.

Furthermore, according to the present invention, the value of each item of the data extracted from the database and the value of each item of the input data are compared, a maximum pattern set and a minimum pattern set are extracted from combination of items coinciding with each other, and then a feature pattern is calculated based on the maximum pattern set and the minimum pattern set. This makes it possible to achieve an effect of providing a feature-pattern output apparatus, a feature-pattern output method, and a feature-pattern output program allowing the feature pattern to be output at high speed with a simple structure.

Moreover, according to the present invention, a common pattern appearing across a plurality of classes is found based on the minimum pattern set, and the feature pattern is calculated as an upper set of the common pattern. This makes it possible to achieve an effect of providing a feature-pattern output apparatus, a feature-pattern output method, and a feature-pattern output program allowing the feature pattern to be output at high speed.

Furthermore, according to the present invention, when similar data is extracted, different conditions are set for the respective classes, and a sufficient number of pieces of similar data is obtained for each class. This makes it possible to achieve an effect of providing a feature-pattern output apparatus, a feature-pattern output method, and a feature-pattern output program allowing the feature pattern to be output at high speed with the entire database being approximated by using the similar data.

Moreover, according to the present invention, as for a maximum pattern appearing across a plurality of classes, its items are excluded to prevent the maximum pattern from being present in classes. This makes it possible to achieve an effect of providing a feature-pattern output apparatus, a feature-pattern output method, and a feature-pattern output program allowing the feature pattern to be output at high speed with high accuracy.

Furthermore, according to the present invention, the input data is classified based on the feature pattern calculated from the similar data. This makes it possible to achieve an effect of providing a feature-pattern output apparatus, a feature-pattern output method, and a feature-pattern output program allowing the input data to be classified at high speed irrespectively of the size of the database.

Moreover, according to the present invention, the number of appearance of the feature pattern in the similar data of the class is counted, and the input data is classified as a class with its count result being the largest. This makes it possible to achieve an effect of providing a feature-pattern output apparatus, a feature-pattern output method, and a feature-pattern output program allowing an output of the feature pattern capable of classifying the input data at high speed and with high accuracy.

Furthermore, according to the present invention, when the item is numerical data, a predetermined numerical area is set, and when the value of an item of the input data and the value of an item of the similar data are within the predetermined area, both of the values of the items are determined to coincide with each other. This makes it possible to achieve an effect of providing a feature-pattern output apparatus, a feature-pattern output method, and a feature-pattern output program allowing the feature pattern to be output at high speed with a simple structure even when the item includes numerical data.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A feature-pattern output apparatus having a database in which data formed of a plurality of items is classified as a plurality of classes, the feature-pattern output apparatus outputting a combination of items forming a feature of each of the classes as a feature pattern of the class, the feature-pattern output apparatus comprising:
a similar-data extracting unit that extracts, when input data is received, similar data that is similar to the input data for each of the classes from the database;
a similar-pattern-set calculating unit that calculates a similar pattern set for each of the classes from the similar data extracted; and
a feature-pattern calculating unit that calculates a feature pattern for each of the classes from the similar pattern set calculated.

2. The feature-pattern output apparatus according to claim 1, wherein the similar-pattern-set calculating unit
extracts, as a pattern set, a combination of items for which a value of each of the items forming the similar data extracted and a value of each of the items forming the input data are identical,
extracts, as a minimum pattern set, a minimum pattern that is a combination of items having no subset except for the combination itself in the pattern set,
extracts, as a maximum pattern set, a maximum pattern that is a combination of items having no upper set except for the combination itself in the pattern set, and
outputs the minimum pattern set and the maximum pattern set as the similar pattern set.

3. The feature-pattern output apparatus according to claim 2, wherein the feature-pattern calculating unit extracts a common pattern appearing across a plurality of classes from the minimum pattern set, calculates a feature pattern including all times included in the common pattern set.

4. The feature-pattern output apparatus according to claim 2, wherein the similar-data extracting unit extracts the similar data from the database based on different conditions for each of the classes.

5. The feature-pattern output apparatus according to claim 4, wherein when there is a maximum pattern appearing across a plurality of classes, the similar-pattern-set calculating unit excludes a predetermined item from the maximum pattern.

6. The feature-pattern output apparatus according to claim 1, further comprising a classifying unit that classifies the input data into any one of the classes based on the feature pattern calculated by the feature-pattern calculating unit.

7. The feature-pattern output apparatus according to claim 6, wherein the classifying unit counts number of feature patterns in the similar data of each of the classes, and classifies the input data as a class having a largest count value.

8. The feature-pattern output apparatus according to claim 1, wherein when a value of a predetermined item forming the input data and a value of an item forming the similar data are within a predetermined value range, the similar-pattern-set calculating unit determines that the values of both items are identical.

9. A feature-pattern output method of outputting, from a database in which data formed of a plurality of items is classified as a plurality of classes, a combination of items forming a feature of each of the classes as a feature pattern of the class, the feature-pattern output method comprising:
extracting, when input data is received, similar data that is similar to the input data for each of the classes from the database;
calculating a similar pattern set for each of the classes from the similar data extracted; and
calculating a feature pattern for each of the classes from the similar pattern set calculated.

10. The feature-pattern output method according to claim 9, wherein the calculating a similar pattern set includes
extracting, as a pattern set, a combination of items for which a value of each of the items forming the similar data extracted and a value of each of the items forming the input data are identical;
extracting, as a minimum pattern set, a minimum pattern that is a combination of items having no subset except for the combination itself in the pattern set;
extracting, as a maximum pattern set, a maximum pattern that is a combination of items having no upper set except for the combination itself in the pattern set; and
outputting, as the similar pattern set, the minimum pattern set and the maximum pattern set.

11. The feature-pattern output method according to claim 10, wherein the calculating a feature-pattern includes
extracting a common pattern appearing across a plurality of classes from the minimum pattern set; and
calculating a feature pattern including all times included in the common pattern set.

12. The feature-pattern output method according to claim 10, wherein the extracting includes extracting the similar data from the database based on different conditions for each of the classes.

13. The feature-pattern output method according to claim 12, wherein when there is a maximum pattern appearing across a plurality of classes, the calculating a similar pattern set includes excluding a predetermined item from the maximum pattern.

14. The feature-pattern output method according to claim 9, further comprising classifying the input data into any one of the classes based on the feature pattern calculated.

15. The feature-pattern output method according to claim 14, wherein the classifying includes
counting number of feature patterns in the similar data of each of the classes; and
classifying the input data into a class having a largest count value.

16. The feature-pattern output method according to claim 9, wherein when a value of a predetermined item forming the input data and a value of an item forming the similar data are within a predetermined value range, the calculating a similar pattern set includes determining that the values of both items are identical.

17. A computer-readable recording medium that stores a feature-pattern output program for outputting, from a database in which data formed of a plurality of items is classified as a plurality of classes, a combination of items forming a feature of each of the classes as a feature pattern of the class, wherein the feature-pattern output program makes a computer execute
extracting, when input data is received, similar data that is similar to the input data for each of the classes from the database;
calculating a similar pattern set for each of the classes from the similar data extracted; and
calculating a feature pattern for each of the classes from the similar pattern set calculated.

18. The computer-readable recording medium according to claim 17, wherein the calculating a similar pattern set includes
extracting, as a pattern set, a combination of items for which a value of each of the items forming the similar data extracted and a value of each of the items forming the input data are identical;
extracting, as a minimum pattern set, a minimum pattern that is a combination of items having no subset except for the combination itself in the pattern set;
extracting, as a maximum pattern set, a maximum pattern that is a combination of items having no upper set except for the combination itself in the pattern set; and
outputting, as the similar pattern set, the minimum pattern set and the maximum pattern set.

19. The computer-readable recording medium according to claim 18, wherein the calculating a feature-pattern includes
extracting a common pattern appearing across a plurality of classes from the minimum pattern set; and
calculating a feature pattern including all times included in the common pattern set.

20. The computer-readable recording medium according to claim 18, wherein the extracting includes extracting the similar data from the database based on different conditions for each of the classes.

21. The computer-readable recording medium according to claim 20, wherein when there is a maximum pattern appearing across a plurality of classes, the calculating a similar pattern set includes excluding a predetermined item from the maximum pattern.

22. The computer-readable recording medium according to claim 17, further comprising classifying the input data into any one of the classes based on the feature pattern calculated.

23. The computer-readable recording medium according to claim 22, wherein the classifying includes
counting number of feature patterns in the similar data of each of the classes; and
classifying the input data into a class having a largest count value.

24. The computer-readable recording medium according to claim 17, wherein when a value of a predetermined item forming the input data and a value of an item forming the similar data are within a predetermined value range, the calculating a similar pattern set includes determining that the values of both items are identical.
